(19) United States
(12) Patent Application Publication
(10) Pub. No.: US 2026/0352449 A1
(43) Pub. Date: Nov. 5, 2026

(54) METHOD AND SYSTEM FOR ONGOING POLARIZATION FEEDBACK AND CONTROL DURING QUANTUM KEY DISTRIBUTION USING DATA ANALYSIS

(71) Applicant: Quantized Technologies Inc., Calgary (CA)

(72) Inventors: Jordan Daniel SMITH, Calgary (CA); Daniel OBLAK, Calgary (CA); Anuj SETHIA, Calgary (CA); Hanen CHENINI, Calgary (CA); Ashutosh SINGH, Calgary (CA); Itzel LUCIO MARTINEZ, Calgary (CA)

(21) Appl. No.: 19/104,972

(22) PCT Filed: Jul. 20, 2024
(86) PCT No.: PCT/IB2024/000368

§ 371 Date: Feb. 19, 2025

Related U.S. Application Data
(60) Provisional application No. 63/527,960, filed on Jul. 20, 2023.

(51) Int. Cl. H04L 9/08; H04B 10/70

(52) U.S. Cl. CPC H04L 9/0852; H04B 10/70

(57) ABSTRACT

A quantum communication system and associated methods are described for securely establishing a cryptographic key between multiple transmitters and a receiver. Each transmitter emits qubit signals from a light source within defined time windows, characterized by specific bases and modes controlled by a transmitter controller. The receiver utilizes an interference device with multiple inputs to receive qubit signals and outputs to generate an interference signal, which is detected by multiple detectors. A receiver controller sends information on detected outputs to transmitters and provides feedback based on polarization characteristics. Simultaneously, the system adjusts subsequent qubit signal characteristics based on this polarization feedback, enabling the establishment of a cryptographic key between transmitters using the detected signals. This adjustment optimizes the cryptographic key rate, enhancing security and efficiency in quantum communication protocols.

### A) TECHNICAL FIELD

The present invention is generally related to the field of quantum key distribution. The present invention is particularly related to polarization feedback and control during quantum key distribution. The present invention is more particularly related to method and system for ongoing polarization feedback and control during quantum key distribution using data analysis.

### B) BACKGROUND OF THE INVENTION

Quantum key distribution (QKD) is a secure communication technique that employs a cryptographic protocol rooted in quantum mechanics principles. This method facilitates the generation of a shared, random secret key between two parties, ensuring that the key remains exclusively known to them. The secret key can subsequently be utilized for the encryption and decryption of messages, providing robust secure communication.

Achieving and maintaining the indistinguishability of two light pulses across this parameter presents a significant technical challenge in generation and manipulation of quantum signals.

Lo, H-K et al. (“Measurement-Device-Independent Quantum Key Distribution” PRL 108, 130503 (2012)) discloses a measurement-device-independent quantum key distribution (QKD) system which removes all detector side channels and doubles the secure distance with conventional lasers.

Berrevoets, R. C., et al. (“Deployed measurement-device independent quantum key distribution and Bell-state measurements coexisting with standard internet data and networking equipment.” Commun Phys 5, 186 (2022)) discloses a Measurement-Device Independent Quantum Key Distribution (MDI-QKD) system, containing a Bell-State measurement node, over the same fiber connection as multiple standard Internet Protocol (IP) data networks, between three nearby cities in the Netherlands. Over 10 Gb/s of classical data communication rates simultaneously with the MDI-QKD system was demonstrated, and 200 GB/s of classical data transmission was predicted to be achievable without significantly affecting QKD performance.

Tang, Y-L et al. (“Measurement-Device-Independent Quantum Key Distribution over Untrustful Metropolitan Network” Phys. Rev. X, 6, 011024 (2016)) discloses measurement-device-independent quantum key distribution (MDIQKD) network in a star topology over a 200-square-kilometer metropolitan area, which is secure against untrustful relays and against detection attacks. In the field test, the system continuously ran through one week with a secure key rate 10 times larger than previous results.

The above-mentioned shortcomings, disadvantages and problems are addressed herein, and which will be understood by reading and studying the following specification.

### C) OBJECTS OF THE INVENTION

The primary object of the present invention is to provide quantum communication systems for the distribution of cryptographic keys, specifically to feedback systems and methods that ensure the maintenance of qubit signal indistinguishability at the receiver during the key distribution process.

Another object of the present invention is to provide a receiver comprising a polarization adjuster configured to alter the polarization of an incoming qubit signal from one of the transmitters prior to its arrival at the interference device.

Yet another object of the present invention is to provide a transmitter emitting qubit signals within specific time windows, corresponding to various bases and modes.

These and other objects and advantages of the embodiments herein will become readily apparent from the following detailed description taken in conjunction with the accompanying drawings.

### D) SUMMARY OF THE INVENTION

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The present disclosure pertains to quantum communication systems for the distribution of cryptographic keys, specifically to feedback systems and methods that ensure the maintenance of qubit signal indistinguishability at the receiver during the key distribution process.

Aspects and features disclosed herein are described in detail below. Unless otherwise specified, any disclosed aspects and features may be combined or used independently.

Provided in accordance with aspects of the present disclosure is a quantum communication system including multiple transmitters and a receiver. Each transmitter emits qubit signals within specific time windows, corresponding to various bases and modes. A transmitter controller regulates these signals. The receiver features an interference device with multiple inputs to receive qubit signals and outputs to generate an interference signal. Multiple detectors detect this signal. A receiver controller transmits detected output signal information to transmitters and provides polarization feedback. The system adjusts subsequent qubit signals based on this feedback, involving polarization characteristics. Moreover, the system uses transmitted information from detected outputs to establish at least part of a cryptographic key between transmitters concurrently.

The polarization feedback enables subsequent qubit signals to be adjusted to maximize cryptographic key rate and qubit signals may be adjusted while the cryptographic key is getting established. Polarization feedback from the receiver is based on information determined from an analysis of a plurality of the detected output signals.

A single detected output signal may serve dual purposes: contributing to the establishment of at least part of the cryptographic key and providing information for polarization feedback to adjust characteristics of subsequently transmitted qubit signals. Adjusting these characteristics aims to enhance the indistinguishability of qubit signals fed into the interference device. Improved indistinguishability can potentially increase the rate of cryptographic key or cipher generation within the system.

The modes within each basis are orthogonal, meaning that no single mode within a basis can be constructed using a linear combination of other modes within the same basis. Additionally, each mode within one basis can be expressed as a linear combination of multiple modes from the other basis.

A qubit or quantum bit is a basic unit of quantum information. A qubit has two distinct states (e.g., one representing “0” and one representing “1”). Unlike a classical bit, a quantum bit can also exist in superposition states, be subjected to incompatible measurements, and/or be entangled with other quantum bits. In the context of this present disclosure, the term “qubit” encompasses two-state qubits, as well as qudits, denoting a unit of quantum information that can be realized in suitable d-level quantum systems (e.g., a three-level “qutrit”).

The system may be configured to make subsequent adjustments to the transmitted qubit signals based on the most recently received feedback and based on previous adjustments and associated feedback.

The qubit signals may be optical signals. A qubit signal may comprise a single photon. The qubit signals may be generally transmitted from the transmitter to the receiver via a fiber optic cable. The qubit signals may also be transmitted from the transmitter to the receiver wirelessly.

Each qubit signal of the transmitted qubit signals may be encoded using early and late time bins within the time window. A characteristic of a qubit signal may be adjusted based on the feedback by the transmitter. A characteristic of a qubit signal may be adjusted based on the polarization feedback by the receiver (e.g., before it reaches the interference device). A polarization adjuster may adjust the polarization of a transmitted qubit signal before it reaches the interference device.

The system includes a polarization adjuster configured to modify the polarization of an incoming qubit signal from one of the transmitters before it reaches the interference device.

The receiver comprises a polarization adjuster configured to alter the polarization of an incoming qubit signal from one of the transmitters prior to its arrival at the interference device. The receiver controller is configured to provide feedback to the polarization adjuster based on the aggregate rate of signals detected by the detectors.

Each polarization adjuster may be configured to modify the polarization of the qubit signals by applying strain to a fiber optic cable through which the qubit signals are transmitted.

At least one of the transmitter and receiver controllers may comprise a Field-Programmable Gate Array. At least one of the transmitter and receiver controllers may comprise a GPU (graphics processing unit) and/or a CPU (central processing unit). At least one of the transmitter and receiver controllers may comprise one or more integrated circuit (IC) microprocessors. At least one of the transmitter and receiver controllers may comprise memory configured to store computer program code.

The transmitter controller may comprise a FPGA. The transmitter controller may comprise a microcontroller. A microcontroller may also comprise a single circuit (IC) chip. A controller may comprise one or more processor cores along with memory and programmable input/output peripherals.

The feedback is provided for an aggregated period, which consists of a predetermined number of qubit signals received (e.g., at least 30 qubit signals). This predetermined number is based on achieving a certain level of statistical significance.

It is determined by a minimum number of output signals needed to calculate the relevant polarization statistics. The aggregated period also includes a predetermined time frame. Further, a single output signal can be used both to generate the cryptographic key and provide feedback to adjust polarization characteristics.

If polarization tends to drift more rapidly, the system may be configured to perform an analysis on the output signals more frequently to generate feedback for that characteristic. Additionally, the number of output signals required to conduct a meaningful analysis is another important factor. If the analysis requires simply a rate of any type of output signal, measuring over a short period of time may provide polarization based meaningful results. However, if only a subset of the total output signals is being used, then the system may be configured to monitor these output signals over a longer period of time to ensure that a polarization meaningful result can be obtained.

The cryptographic key may be established based on information relating to detected output signals corresponding to suitable entangled basis states. In the case of two transmitters, the suitable entangled basis states may be Bell states. In the case of more than two transmitters, the suitable entangled basis states may be Greenberger-Horne-Zeilinger (GHZ) states.

The cryptographic key may be established based on information relating to detected output signals corresponding to a photon in an early time bin detected at a first detector and a photon in a late time bin detected at a second detector.

In another aspect of the present disclosure, there is provided a quantum communication system receiver comprising: an interference device having multiple inputs configured to receive multiple series of qubit signals from multiple transmitters and multiple outputs configured to produce signals based on the interference of the received qubit signals at the interference device; multiple detectors configured to detect the output signals at the multiple outputs of the interference device; and a receiver controller configured to transmit information relating to the detected output signals to the transmitters, and to provide feedback based on the outputs, wherein the feedback comprises polarization information on a plurality of the detected output signals and corresponds to the following polarization characteristic of the qubit signals.

In still yet another aspect of the present disclosure, an interference device may comprise a single beam splitter. An interference device may comprise multiple beam splitters. An interference device may consist of passive optical components.

In another aspect of the present disclosure, there is provided a method for establishing at least a portion of a cryptographic key, the method comprising: transmitting a series of qubit signals from multiple transmitters, each qubit signal being within a respective time window and corresponding to a basis within a plurality of bases and a mode within a plurality of modes of the basis; and controlling the series of qubit signals emitted by a light source; receiving the qubit signals at a receiver; interfering multiple qubit signals from the multiple transmitters to produce an interference output signal based on interference at the interference device; detecting the output signal at multiple outputs; and transmitting information relating to the detected output signals to the transmitters, automatically providing polarization feedback based on an analysis of the detected output signals over a period of time, wherein the feedback corresponds to polarization characteristics of the qubit signals, wherein the characteristics comprising polarization similarity of the qubit signals, and concurrently enabling adjustment of subsequently transmitted qubit signals based on the received feedback and establishing at least part of a cryptographic key between the transmitters based on the transmitted information relating to the detected output signals. The method comprises adjusting polarization characteristics of subsequently transmitted qubit signals based on the received feedback.

In yet another aspect of the present disclosure, a single photon detector may comprise one or more of the following: a photomultiplier tube (PMC), a hybrid photodetector (HPM), a single-photon avalanche diode, and a superconducting nanowire single-photon detector (SNSPD).

In still yet another aspect of the present disclosure, Quantum key distribution (QKD) is a secure communication method employing a cryptographic protocol based on quantum mechanics. It allows two or more parties to generate a shared secret key known only to them, which can be used to encrypt and decrypt messages. The key may consist of an ordered string of bits or characters. To ensure a key is considered secure, it must meet two criteria:
1) It must be correct, meaning the key bit strings held by Alice and Bob must be identical.
2) It must be verifiably secret, ensuring the key bit string is known only to Alice and Bob and not to any third party.

Each qubit signal in the series of qubit signals may have the same or approximately the same intensity (e.g., within ±10% of a mean average). Some embodiments may use a decoy state protocol specifying different intensities for different intensity categories, such as “signal” states, “decoy” states, and “vacuum” states. In these embodiments, each qubit signal within the same intensity category may have the same or approximately the same intensity (e.g., within a predetermined range, such as ±10%, of a mean average). Each qubit signal within the series of qubit signals possesses an approximately identical polarization profile.

A polarization adjuster is used to control or change the polarization of an incoming qubit signal. The polarization adjuster can be a polarization controller. The clock rate of the light source is required to be more than 200 MHz. The time window of each qubit pulse is less than 5 ns.

In another aspect of the present disclosure, when emitted from the transmitter, a signal that is ultimately utilized for establishing the cryptographic key may be identical (e.g., in terms of polarization) to a signal that is ultimately utilized for providing polarization feedback to the transmitter. The utilization of the signal may be determined by various factors, including one or more of: the signal transmitted concurrently within the same time window by other transmitters, the manner in which the signal traverses through the interference device, and the basis selected by each of the transmitters.

The output signals utilized for establishing at least part of the cryptographic key may additionally contribute to the polarization information employed to adjust characteristics of subsequently transmitted qubit signals.

In another aspect of the present disclosure, qubit signals may incorporate decoy states. Practical QKD systems utilize multi-photon sources, deviating from the ideal BB84 protocol, thereby rendering them vulnerable to photon number splitting (PNS) attacks. Addressing this inherent vulnerability of practical QKD systems involves employing a decoy state technique, wherein multiple intensity levels are used at the transmitter's source. For instance, Alice transmits qubits using varying intensity levels (one signal state and several decoy states), each exhibiting diverse photon number throughout the channel. Post-transmission, the transmitter publicly discloses which intensity level was employed for transmitting each qubit.

In yet another aspect of the present disclosure, the light source may comprise one or more of: a laser, a single molecule, a Rydberg atom, a diamond color center, a defect center within a lattice, and a quantum dot.

In still yet another aspect of the present disclosure, the cryptographic key can be established exclusively using information derived from detected outputs, where one photon is detected in an early time bin at a first detector, and another photon is detected in a late time bin at a different second detector.

In still yet another aspect of the present disclosure, the system employs a calibration phase where robust signals containing multiple photons are transmitted from the transmitters to the receiver. This phase aims to establish initial conditions for tuning the polarization of the transmitters, thereby ensuring the reception of indistinguishable qubit signals at the interference device.

In still yet another aspect of the present disclosure, analysis is beneficial due to the dependence of specific outputs on quantum states, which inherently yield random outcomes upon measurement (e.g., originating from qubit signal generation or interference at the device). Consequently, identical setups of multiple systems would typically yield differing outputs. However, over time, the analysis should yield a sufficiently consistent set of results to enable meaningful polarization feedback.

In another aspect of the present disclosure, the detection rate of a specific output signal may involve measuring the time required to reach a predefined count of detected signals, and/or tallying the number of detected signals within a set time interval. Essentially, this rate reflects the frequency of detections over a specified timeframe.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### E) BRIEF DESCRIPTION OF THE DRAWINGS

The other objects, features and advantages will occur to those skilled in the art from the following description of the preferred embodiment and the accompanying drawings in which:

In the detailed description section below, one or more embodiments of the present technology are described in relation to the attached figures. These embodiments are intended to provide a better understanding of the invention, how the invention may be put into practice, and to demonstrate some of the advantages of the invention. The drawings are not necessarily to scale, emphasis instead being placed upon illustrating the principles of various embodiments of the invention. Various aspects and features of the present disclosure are described hereinbelow with reference to the drawings wherein like numerals designate similar elements in each of the several views and:

FIG. 1a is a schematic overview of an embodiment of a quantum communication system

FIG. 2a is a graph of the response time of the polarization adjuster to perturbations in the polarization state as a function of step size

FIGS. 2b and 2c shows the response of a polarization adjuster to a perturbation induced by a manual polarization controller

FIG. 3 Method of Establishing a Cryptographic Key

Although the specific features of the present invention are shown in some drawings and not in others. This is done for convenience only as each feature may be combined with any or all of the other features in accordance with the present invention.

### F) DETAILED DESCRIPTION OF THE DRAWINGS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

As previously noted, various techniques have been proposed for utilizing quantum mechanics to establish a shared key between multiple users. The application of quantum mechanics enables the two communicating users to ascertain whether a third party is attempting to obtain information about the key (e.g., through eavesdropping).

In the category of quantum communication systems described herein, two users transmit qubits to a central receiver where the qubits can interact with each other via an interference device. It is crucial that the qubits are sufficiently indistinguishable to facilitate the establishment of a key.

Historically, various methods have been employed to ensure that qubits are indistinguishable. These methods include:
Utilizing a calibration mode where strong laser pulses are sent by the transmitters without any decoy or qubit modulation and scanning the wavelength, as detailed in the background section.
Employing strong laser pulses and scanning while monitoring a beat frequency to ensure the lasers maintain spectral consistency.

In both scenarios, the light sources are adjusted using additional modes-such as distinct from those used for distributing the cryptographic key. This ensures that the polarization of the light from each source is aligned. Subsequently, the light source is switched to a qubit mode with modulated lower intensity, which is then utilized to transmit qubit signals for the purpose of establishing or distributing the cryptographic key.

Further, quantum key distribution can be enhanced by reducing or eliminating drift in the light sources during the distribution process. Although the light sources may initially emit sufficiently indistinguishable qubit pulses following calibration over polarization profile of the qubit signals may drift. This drift reduces the degree of indistinguishability, leading to a decrease in the key generation rate and potentially resulting in a shorter key being established over a given time period, which can be problematic if a minimum key length is required.

A method has been devised for continuously monitoring the degree of indistinguishability during key distribution and providing feedback to allow real-time adjustments to the qubit signals, ensuring that any drift or perturbation in the transmitters and/or quantum transmission lines can be effectively compensated.

The disclosed invention pertains to a system wherein the receiver autonomously provides feedback based on detected outputs to facilitate adjustments in the transmitted signals, thereby enhancing their indistinguishability. This feedback pertains specifically to the polarization similarity of the qubit signals.

The system is configured to automatically adjust the transmitted qubit signals based on the received feedback in real time; and establish a cryptographic key between the transmitters based on the outputs signals.

Various aspects of the invention are described with reference to the figures. For illustrative purposes, the components depicted in the figures are not necessarily drawn to scale; rather, emphasis is placed on highlighting the contributions of the components to the functionality of the invention. Throughout the description, several alternative features are introduced. It should be understood that, according to the knowledge and judgment of a person of ordinary skill in the art, these alternative features may be substituted in various combinations to achieve different embodiments of the invention.

### Quantum Communication System

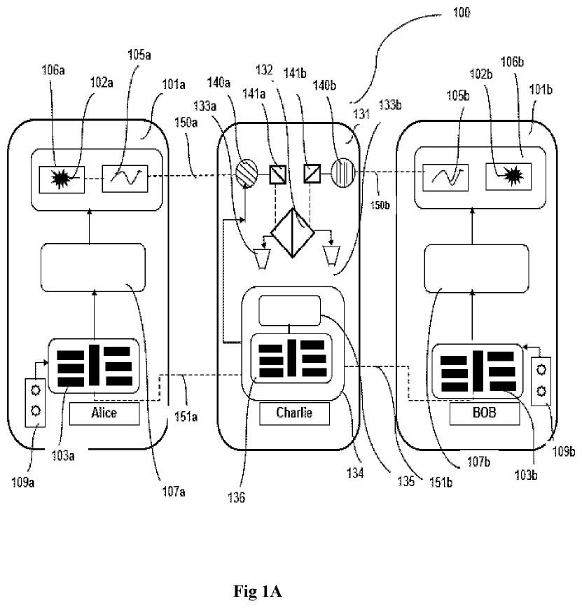

Referring to FIG. 1a, FIG. 1a illustrates the structure of quantum communication system.

FIG. 1a shows a quantum communication system 100 comprising at least two transmitters 101a, b and a receiver 131. As is customary in the field, the transmitters (or users) are named Alice (101a) and Bob (101b) and it is these devices that are trying to establish, transmit or distribute a common cryptographic key. The receiver is named Charlie (131).

In quantum key distribution, Eve typically represents a third-party entity attempting to intercept the generated key without detection by the transmitters (and possibly the receiver). Transmitters (101a, 101b) are generally assumed to be trustworthy, while the trustworthiness of the receiver, Charlie (131), remains uncertain. In the context of MDI-QKD (Measurement-Device-Independent QKD), Eve possesses full knowledge of the central node's operation, measurement outcomes, and hardware access. Consequently, MDI-QKD does not differentiate between Charlie and Eve at the central node, treating the central node itself as untrustworthy due to Eve's potential capabilities and access.

Each transmitter (101a, 101b) includes: a light source (106a, 106b) designed to emit a series of qubit signals, where each qubit signal consists of one or more quantum pulses arranged in time bins and within a specified time window; and a transmitter controllers (103a, 103b) configured to manage the emission of the series of qubit signals from the light source.

The qubit signals are transmitted through a quantum channel using fiber optic cables (150a, 150b). These cables can vary in length, for instance, up to 200 km, and may be laid out in diverse configurations. Alternatively, in some scenarios, qubit signals can be transmitted through free space, such as when Charlie (131) is positioned on a satellite or communicating wirelessly with the transmitters.

The receiver includes an interference device (132) with multiple inputs designed to receive the series of qubit signals, and it features multiple outputs that generate an output signal based on the interference occurring within the device. Additionally, there are multiple detectors (133a, 133b) within the receiver (131) configured to detect the output signal at the various outputs of the interference device.

The receiver also includes a receiver controller (134) designed to analyze the output signals detected by the detectors (133a, 133b) and to autonomously provide feedback based on these detected signals. The feedback pertains to polarization similarity characteristic of the qubit signals. Information regarding the output signals can be conveyed back to the transmitters (101a, 101b) through a classical communication channel, which may utilize fiber optic cables (151a, 151b) in certain embodiments. Alternatively, in other configurations, communication may occur through free-space channels. In some embodiments, parts of the feedback information may also be transmitted through a classical network, such as the Internet, which may or may not involve the use of fiber optic or free-space channels.

Each qubit signal corresponds to one basis of a plurality of bases, and a mode of a plurality of modes within that basis. For example, as in the original BB84 protocol, if the system used polarization of light, one basis might be vertical and horizontal polarizations, and the modes would be the vertical polarization, |⬆ [symbol] , and the horizontal polarization, |→ [symbol] . Another basis could be two diagonal polarizations, with the modes being a positive diagonal polarization, | [symbol] , and a negative diagonal polarization, | [symbol] . It will be appreciated that each mode of each basis is a superposition of the modes of the other basis.

### Quantum Key Distribution Protocol

An MDI-QKD protocol is illustrated as below in Table 1 and proceeds as follows:
I. Alice and Bob agree on what each state represents in the computational basis (e.g., let |e [symbol] ,|+ [symbol] =0 and |l [symbol] ,|− [symbol] =1). Both Alice and Bob prepare phase-randomized WCPs (Weak

TABLE 1
Illustration of the MDI-QKD protocol

| Alice basis | Z | X | Z | X | X | Z |
|---|---|---|---|---|---|---|
| Alice bit | 1 | 0 | 0 | 1 | 1 | 1 |
| Alice state | \|l [symbol] | \|+ [symbol] | \|e [symbol] | \|− [symbol] | \|− [symbol] | \|l [symbol] |
| Bob basis | X | X | Z | Z | X | Z |
| Bob bit | 1 | 1 | 1 | 0 | 1 | 0 |
| Bob state | \|− [symbol] | \|− [symbol] | \|l [symbol] | \|e [symbol] | \|− [symbol] | \|e [symbol] |
| Charlie/Eve BSM | \|Ψ⁻ [symbol] | \|Ψ⁻ [symbol] | None | None | \|Ψ⁺ [symbol] | \|Ψ⁺ [symbol] |
| Same basis? | No | Yes | Yes | No | Yes | Yes |
| Alice sifted key | | 0 | | | 1 | 1 |
| Bob sifted key | | 1 | | | 1 | 0 |
| Sifted key | | 0 | | | 1 | 1 |

| | |
|---|---|
| QBER ≤ 11%? | Yes |

Coherent Pulse) in the four possible states-here time-bin encoding is used-and send them over public channels to an untrusted relay, Charlie (or Eve).

II. The untrusted relay, Charlie, performs a Bell-state measurement (BSM) that projects the incoming signals onto a Bell state. Such a projective measurement can be accomplished using only linear optical elements. In this case, projections are restricted to |ψ± [symbol] .
   Projection onto one or more Bell states allows a successful security proof.
III. Alice and Bob apply decoy-state techniques to estimate the yield and quantum bit error rate (QBER) for various input photon numbers.
IV. Charlie announces over a public channel, which events result in a successful BSM, along with the results of the measurement (in cases where more than one Bell-state is used in the protocol).
V. Alice and Bob keep the data corresponding to their qubits that resulted in a successful BSM and discard the rest. They also communicate their basis choices via a public channel to post-select the events in which they used the same qubit-preparation basis.
VI. Alice and Bob account for how the system responds to establish a common cryptographic key. In this embodiment, except for the events in which both Alice and Bob prepare qubits in the X-basis and Charlie successfully measures the |ψ+ [symbol] Bell-state, the remaining key bits belonging to Alice and Bob are anti-correlated and require either Alice or Bob to apply a bit-flip to their data.
VII. Typically, the final step in the process is that the common quantum key is then classically post-processed to remove any errors in the keys possessed by Alice and Bob, and to remove any information that Eve may have obtained about the mutual key shared by Alice and Bob.

Regarding the Bell states, the protocol utilizes quantum interference of photons from separate sources and a projective Bell-state measurement (BSM), resulting in an entangled-state measurement only when the photons are annihilated upon detection. The Bell basis includes the maximally entangled states:

$$\vert {Φ}^{\pm } 〉 = \frac{1}{\sqrt{2}} ( \vert {e}_{1} {e}_{2} 〉 \pm \vert {l}_{1} {l}_{2} 〉 )$$

$$\vert {Ψ}^{\pm } 〉 = \frac{1}{\sqrt{2}} ( \vert {e}_{1} {l}_{2} 〉 \pm \vert {l}_{1} {e}_{2} 〉 )$$

After passing through the beam splitter, the measured outputs at outputs 3 and 4 correspond to the following:

$$\vert {Ψ}^{+} 〉 {\to }^{BS} \frac{i}{\sqrt{2}} ( \vert {e}_{3} {l}_{3} 〉 + \vert {e}_{4} {l}_{4} 〉 )$$

$$\vert {Ψ}^{-} 〉 {\to }^{BS} \frac{1}{\sqrt{2}} ( \vert {e}_{3} {l}_{4} 〉 - \vert {l}_{3} {e}_{4} 〉 )$$

$$\vert {Φ}^{+} 〉 {\to }^{BS} \frac{i}{2} ( \vert {e}_{3} {e}_{3} 〉 + \vert {e}_{4} {e}_{4} 〉 + \vert {l}_{3} {l}_{3} 〉 + \vert {l}_{4} {l}_{4} 〉 )$$

$$\vert {Φ}^{-} 〉 {\to }^{BS} \frac{i}{2} ( \vert {e}_{3} {e}_{3} 〉 + \vert {e}_{4} {e}_{4} 〉 - \vert {l}_{3} {l}_{3} 〉 - \vert {l}_{4} {l}_{4} 〉 )$$

Not all of the possible input states from Alice and Bob undergo quantum interference at the receiver's beam splitter, such as input Z-basis states |e) and |I). Given that the wavefunctions of these two states have no overlap, they do not interfere in a beam splitter and can, therefore, be considered orthogonal states in Hilbert space. Whether the input states from Alice and Bob are orthogonal or not in the degree of freedom of interest, they must still be indistinguishable in other degrees of freedom, including polarization similarity for a Bell-state projection to be possible.

This constraint is due to the requirement for no possible ‘which-path’ information that could correspond to correlations between photon detections and their sources.

The Bell-state measurement is the foundation of the “measurement-device-independent” property of MDI-QKD, since measurement results are not one-to-one with prepared qubits. Rather, prepared qubits are two-to-one with measurement results, as Alice and Bob each prepare a qubit for every Bell-state measurement result. The consequence is that each measurement result does not announce information about a specific monopartite quantum state of a photon, which could reveal information about the key to a third party, such as Eve, but rather it announces a correlation relation between the two qubits prepared by Alice and Bob corresponding to the specific Bell-state measurement event. Finally, this means that even if Eve has full information about the measurement results, at best she knows only about the correlation between the qubits sent by Alice and Bob, and knows nothing about the final bit string that becomes their secure key.

After sifting the raw key, Bob applies a bit-flip to his sifted key except where both Alice and Bob prepared a qubit in the X-basis and the BSM resulted in a |ψ+ [symbol] projection. After using decoy-state techniques to estimate QBER, if the value is ≤11% the secure key is kept and error correction and privacy amplification are applied, otherwise the key is discarded, and the protocol is repeated.

Although a complete network may support a star-type topology, a first embodiment, as illustrated in FIG. 1a, includes just two end users, Alice and Bob, and a central node, Charlie.

Qubit generation is accomplished according to a decoy-state protocol and is controlled using random bits from quantum random number generators (QRNGs) by field-programmable gate array (FPGA) units. The decoy-state protocol and the optical isolators at the end users are useful to prevent side-channel attacks on the photon sources operated by the end users.

System parameters, such as channel loss and propagation delay, are estimated before key-exchange commences, so that WCP attenuation can be adjusted to optimize the various levels of the decoy-state protocol and each end user can correlate their received BSM (Bell State Measurement) signals with their transmitted qubits. After key exchange, classical post-processing (error correction and privacy amplification) of the data is done via automated processes performed by the FPGAs at the end-users (transmitters). The quantum and classical signals will be compatible with classical telecommunications signals sent over the same fibers by means of dense wavelength division multiplexing (DWDM) to mitigate the noise effects of Raman scattering.

Qubits are sent from Alice and Bob to Charlie for Bell-state measurement. Photon detection is achieved at Charlie using a single photon detector. Time-reversed entanglement is created by passing indistinguishable WCPs from Alice and Bob through a beam splitter interference device and detecting them via single photon detectors, where bipartite detection (e.g., detection of photons at two separate detectors) enables a BSM projection onto the |ψ− [symbol] state. In this embodiment, only the |ψ− [symbol] state is used for key distribution. Other embodiments may use other multipartite entangled states (e.g., GHZ states or multiple Bell states) for key distribution.

The central node at Charlie includes a synchronizing clock signal, as well as feedback-based control systems to ensure that the end users produce qubits that are indistinguishable in the polarization degrees of freedom as they arrive at and are overlapped on Charlie's beam-splitter.

It will be appreciated that, in quantum mechanics, the indistinguishability of two photons is a continuous variable. That is, it is theoretically possible to have completely distinguishable or indistinguishable photons, but in practical terms, it is possible to have completely distinguishable photons, completely indistinguishable photons, and partially indistinguishable photons. Indistinguishable photons are those which are sufficiently indistinguishable such that they interact with each other at the interference device to a sufficient degree to permit a cryptographic key to be established. That is, indistinguishable photons may include partially indistinguishable photons.

### Alice and Bob Transmitters

Alice and Bob transmitter devices 101a and 101b have an identical structure. The hardware architecture located at Alice and Bob (101a and 101b) contains all components and control systems necessary to generate qubits and send them to Charlie (131) through a quantum channel. As the experimental setup belonging to Alice and that belonging to Bob are identical, only one will be described in the following.

Alice and Bob (101a and 101b) may have the same hardware architecture, but one transmitter (e.g., Alice) may have additional code to allow her to receive feedback from Charlie (131) to adjust the output of her laser to match its wavelength with that of Bob's laser.

The light source 106a, 106b in this embodiment comprises: a laser (102a, 102b) which is a semiconductor-type laser, and various optical components 105a, 105b used to modulate and convert the raw laser pulse into a qubit signal. The laser operates at a single wavelength (e.g., of ~1550 nm).

Changing the temperature of the cavity, using a temperature controller, causes expansion or contraction of laser cavity length, and a subsequent change in the index of refraction. Consequently, the optical path length of the cavity changes, allowing for tuning of the central wavelength as needed to match the wavelengths emitted by Alice and Bob (101a and 101b). The light source is controlled by a transmitter controller, which in this case uses an FPGA (103a, 103b). The transmitter controller (103a, 103b) controls the laser driver (which provides a stable current supply for the laser diode), and the temperature controller.

Generally, the laser should have a linewidth of below a predetermined threshold value (e.g., 2 MHz). The predetermined threshold linewidth value may be configured to meet a certain threshold percentage of erroneous BSM detections. These thresholds may be determined according to the need for generating a key (e.g., key length, rate of key generation etc.). The laser may have a power of less than 40 mW. The laser may be tunable such that the central wavelength can be controlled within less than a nanometer.

Regarding the transmitter controller 103a, 103b, the FPGA 103a, 103b is an integrated circuit with an array of programmable logic blocks that perform logical computations at the hardware level, rather than using software for computation. An advantage of using arrays of logic blocks is that they are much faster than soft microprocessors in some applications, due to their parallel nature and optimality in the use of logic gates. Commercial FPGA architectures often integrate micro-processing systems and related peripherals that can be used as a complete “system on a programmable chip”.

The FPGAs in the design act as the hardware-control and data-processing units for the system, with an FPGA unit located at each transmitter (and the receiver). The FPGAs at the locations of Alice and Bob have an identical function in terms of qubit state preparation. At Alice and Bob (101a, 101b), the FPGA takes random bits of data as input from an external QRNG 109a, 109b (Quantum Random Number Generator) and then translates that data into a particular state to be prepared for each qubit. The FPGA then sends output signals to each hardware component in the state-preparation setup, resulting in qubits being prepared and sent to Charlie (131). In this embodiment, these transmitted qubits are initially used to estimate the channel loss and propagation delay of the system, after which they are used to perform the MDI-QKD protocol. In other embodiments, higher power classical intensities could also be used to perform calibration. The specific input and output signals from Alice's FPGA will be discussed along with the different peripherals that send (receive) signals to (from) the FPGA.

FPGAs of Alice and Bob have similar or identical functions with the exception of 1. taking different feedback signals and using them to control indistinguishability characteristics, e.g., laser wavelength. 2. In the post-processing step, either Alice or Bob (101a, 101b) may send asymmetric information to the other to inform an action to ensure that their secure keys are identical and private.

The respective propagation times between Alice and Charlie, 150a and Bob and Charlie, 150b may vary with time (e.g., due to thermal fluctuations in the optical fiber links 150a, 150b).

As Charlie distributes the master clock to both Alice and Bob, the FPGA in this embodiment adjusts the phase of the master clock signal sent to Bob to match the arrival time of Alice's and Bob's qubits at Charlie. Based on previous experiments using deployed fibers, the timing drift may range from 0 to 10 ps per minute, depending on the fiber link. This drift is sufficiently small to enable the acquisition of pulse-timing data with adequate statistical significance to compensate for the drift.

For the controllers 103a,b of the transmitters and of the receiver to accomplish the tasks described above, they require certain capabilities: sufficient clock rate to process data and output the necessarily fast electrical signals to peripheral devices, sufficient memory to store the data used to generate the secure key, sufficient input/output (I/O) ports to interface with all necessary peripherals, a sufficient number of processors to multi-task, and a sufficient number of programmable logic (PL) cells to perform simultaneous logic operations. Generally, the transmitter and/or receiver controllers should have a clock rate of at least 400 MHz.

Further, the light source is controlled by the transmitter controller via electrical conditioning components 107a, 107b. As noted above the light source comprises: a laser 106a and optical conditioning components 105a, 105b for converting the raw light signal into a qubit signal.

The optical conditioning components in this case may comprise one or more of: an intensity modulator, a phase modulator, a pulse modulator, an attenuator, a beam splitter, and an isolator. The electrical conditioning components may comprise one or more of: a digital to analog converter (fast and or slow); an analog to digital converter; a RF amplifier and a DC amplifier.

The general purpose of an intensity modulator is to create the optical pulses encoding the time-bin states based on the electrical signals from the transmitter controller 103a, 103b. The electro-optic intensity modulator takes an optical signal from the laser with a time-varying electrical signal as inputs, and it produces a time-varying optical signal as output. Specifically, in the task of qubit preparation in this embodiment, the purpose of the first intensity modulator is to take a 2.5 ns pulse from the laser as input, and to suppress that pulse entirely (or at least sufficiently, e.g., by a factor of 100, or to at least 30 dB).

In this embodiment, the working principle of the intensity modulator is that of a phase-modulated Mach-Zehnder interferometer (MZI), in which an electro-optic intensity modulator takes an incoming optical signal and splits it into two arms via a beam splitter. It also takes an electrical input signal to produce an electric potential difference in one arm across the wave-guide medium (LiNbO3 in this case) changing its polarization-dependent index of refraction, an effect referred to as the Pockels effect. The result is a relative change in the optical path-length between the two arms, producing a phase shift in the signal traversing the first arm relative to the signal in the second arm. The optical signals from the two arms are recombined using another beam splitter, at which they interfere. The result is that, by applying the appropriate voltage to the IM, there is constructive interference at the output port when an optical signal is desired, and complete destructive interference, corresponding to a relative π-shift in the phase-modulated arm, or Δφ=mπ for odd m, when an optical signal is not desired. In other embodiments, other types of intensity modulators may be used.

For the present design, the intensity modulator must meet specific criteria: it needs sufficient bandwidth to swiftly modulate and generate distinct time-bin signals. Additionally, the extinction ratio (ER), which denotes the ratio of complete constructive to complete destructive interference, must be sufficiently high. This ensures excellent contrast and a high signal-to-noise ratio (SNR). Maintaining a high ER is crucial because any failure to fully suppress laser pulses outside of the desired time-bins can lead to erroneous detections at Charlie, thereby increasing the Quantum Bit Error Rate (QBER)

Generally, the intensity modulator should have a bandwidth of at least 10 GHz and span the frequency range of the light source. The extinction ratio of the intensity modulators should be greater than 30 dB for DC signals and greater than 20 dB for radio frequency (RF) signals.

Separate intensity modulators may serve different functions. For instance, a first intensity modulator could create time-bin states by modulating the intensity of input laser pulses over time. Meanwhile, a second intensity modulator might adjust the overall intensity within a clock cycle to implement varying intensities required by the decoy-state protocol. The vacuum state could be generated by completely suppressing the optical signal using both intensity modulators in series. Additionally, the relative intensities of the signal and decoy states could be controlled using the second intensity modulator.

The phase modulator (PM) is designed to take an optical signal and an electrical input signal to induce a shift in optical path length, thereby producing a phase-shifted optical output signal. Similar to the electro-optic intensity modulator (IM), the electro-optic PM utilizes the Pockels effect to achieve this phase shift. In the experimental setup, the specific role of the phase modulator is to introduce a π-phase shift in the late time-bin when preparing the state. |− [symbol] =(1/\sqrt{2})(|e [symbol] +eⁱⁿ|l [symbol] )=(1/\sqrt{2})(|e [symbol] −|l)). The waveguide medium employed in this instance is LiNbO3.

The performance requirements of the phase modulator are similar to those of the intensity modulator, with some exceptions. Specifically, the required bandwidth of the phase modulator is less than half that of the intensity modulator, as it only needs to modulate the optical phase of the late time-bin and not the early one. Unlike the intensity modulator, there is no requirement for extinction ratio (ER) in the phase modulator since it does not involve optical interference. Additionally, there is no DC-bias voltage applied to the phase modulator. Control of the phase modulator is managed by the transmitter controller 103a, 103b through electrical conditioning components. Generally, the phase modulator should have a bandwidth of at least 5 GHz.

Additionally, it is crucial that there be no information allowing Eve to distinguish between the prepared states. Therefore, the mean optical power of laser pulses used to prepare both Z-basis and X-basis states must be identical. The X-basis states, which consist of two pulses, achieve this by ensuring that each time-bin in X-basis states has half the intensity of the time-bins prepared in Z-basis states.

To ensure random state generation as required by the MDI-QKD protocol, a source of true random numbers is essential. A Quantum Random Number Generator (QRNG) 109a, 109b relies on non-deterministic quantum measurement results to produce random bits of data. QRNGs typically provide specifications such as an entropy data rate and a post-processed data rate. The entropy data rate represents raw data resulting from measurements using imperfect hardware and non-uniform probability distributions. To remove biases from this data, various post-processing methods are employed, often resulting in the discarding of some bits to achieve unbiased, uniformly distributed random data. Consequently, the post-processed data rate is generally lower than the entropy data rate, often by nearly an order of magnitude in commercial devices.

In this embodiment, Alice and Bob each require 1 Gbps of post-processed random data for random state preparation and decoy level selection. The QRNGs used in the architecture also include interface modules to communicate with FPGAs via Ethernet or other I/O ports.

After generating qubits using relatively high-intensity optical signals controlled by the transmitter controller, laser, and intensity and phase modulators, it is necessary to attenuate the signal intensity to ensure the mean photon number of the qubits, μ, is <1. This attenuation is achieved using a combination of manual and electronic variable optical attenuators (VOAs).

In this embodiment, variable optical attenuators function by transmitting a diverging optical signal, in free space, into a collimating lens. The proportion of the collimated beam that is displaced away from the coupler into the outgoing fiber determines the level of attenuation.

The VOAs should be designed to operate effectively at 1550 nm wavelength and offer variable attenuation capabilities up to ≥70 dB. The setup includes VOAs with a combined attenuation range of 3-75 dB.

To mitigate source-targeting adversarial attacks, such as laser-seeding and Trojan Horse attacks, an optical isolator (ISO) is employed to enable one-way propagation of optical signals from Alice/Bob (101a, b) to Charlie (131). In this embodiment, the optical isolators, also known as Faraday isolators, utilize magneto-optic principles involving birefringence and polarization rotation. They transmit light in the forward direction while absorbing or deflecting light traveling in the reverse direction.

The isolator in the experimental design should ensure low-loss propagation of outgoing 1550 nm light while providing at least 50 dB of isolation for incoming light.

In this embodiment, the transmitter receives feedback from Charlie via a fiber optic channel 151a. The received optical signal is converted to an electrical signal via a dense wavelength-division multiplexing (DWDM) small form-factor pluggable (SFP) transceiver. In the transmitter, the transceiver takes as input a multiplexed optical signal, i.e., a superposition of different wavelengths, and demultiplex it into its component wavelengths. It then converts the optical signals to electrical output signals which can be read by the transmitter FPGA 103a, 103b.

The requirements of the DWDM SFP are that it should have at least 3 channels to be capable of multiplexing/demultiplexing 3 separate signals, it should transmit/receive optical signal over at least 50 km of fiber, it should operate at a central wavelength of 1550 nm, and it should have a high enough bandwidth to process and send clock, measurement results, and feedback data from Charlie (131).

### Charlie (131) Receiver

The hardware setup at Charlie (131) includes electronic and photonic components essential for performing Bell State Measurements (BSMs), implementing synchronization and polarization control systems, and delivering measurement results, clock signals, and necessary feedback to Alice and Bob (101a, 101b).

The receiver controller 134, in this case comprising FPGA 136, resembles those found in Alice's and Bob's setups. At Charlie, the FPGA is synchronized with the master clock and receives input signals from logic board 135. This board provides Bell State Measurement (BSM) information based on signals from the single photon detectors 133a, 133b. Additionally, logic board 135 routes raw output signals from the single photon detectors directly to the FPGA without modification.

FPGA 136 uses the rate of total detection counts of one or both single photon detectors to output a feedback signal to the polarization adjusters 140a, 140b in order to maximize the number of photons in the desired polarization state. The correct polarization state yields the highest counts is that a polarizing beam splitter 141a, 141b is placed between the interference device 132 and the polarization adjusters 104a, 140b.

The interference device comprises a polarization-maintaining beam splitter (PMBS) 132 configured to combine photonic signals at its two input ports, allowing them to interfere without altering their polarization state. The PMBS evenly divides the combined optical signal, maintaining a 50:50 ratio between its two output ports. Hence, it is referred to as a 50:50 PMBS. The critical importance of indistinguishability between Alice's and Bob's qubits in polarization degree of freedom is demonstrated. The time-reversed entanglement process employed requires quantum interference at the PMBS, followed by a detection pattern at the single photon detectors 133a and 133b, which projects onto a Bell state.

The complementarity principle states that quantum interference necessitates the absence of ‘which-path’ information when photons emerge from an interference event, such as within a beam splitter. This implies that even the potential availability of such path information, regardless of whether it is actually measured, can degrade interference.

The requirements of the PMBS are simple, it must be compatible with 1550 nm photonic signals, it must divide the output signal 50:50 between the two output ports, and it must not alter the linear polarization state of the optical signals propagating parallel to the optical axis of the beamsplitter.

When considering indistinguishability between Alice's and Bob's qubits, matching in the polarization degree of freedom can be achieved using parallel polarization-axis output ports from polarizing beam splitters (PBSs) respectively channeling Alice's and Bob's qubits to the central PMBS at Charlie. Thus, the purpose of the PBS in the experiment is to align the polarization axes of Alice's and Bob's qubits before arriving at the PMBS for quantum interference and subsequent detection.

The requirements of the PBS are simple. First, it must be sensitive to optical signals at 1550 nm. Second, it must output orthogonal polarization state components of the input signal at the two output ports.

PBSs ensure polarization-dependent indistinguishability between qubits from Alice and Bob, the important polarization-dependent characteristic, then, is actually the gain of Alice's and Bob's signals, which depends on the proportion of signal that gets split into the desired output port of each PBS. Maximizing the gain of the system increases its secure-key rate and secure distance, which are the two key-performance-indicators (KPIs) of any QKD system. Thus, the importance of maximizing the proportion of signal that is output into the desired port of each PBS is evident.

The two single photon detectors in the experimental design primarily serve to perform Bell State Measurement (BSM) projections. These detectors achieve BSM, through bipartite detection of qubits from Alice and Bob (101a, b), detecting signals that arrive at both detectors simultaneously.

The purpose of the polarization adjusters in the experimental architecture is to maximize the photonic signal at the output port of the PBSs that is connected to the PMBS. Due to the polarization dependence of that output port, the role of the polarization adjuster is to rotate the polarization state of the incoming photonic signal to be parallel with the polarization axis of that desired PBS output port. In the polarization adjuster used in the experiment, rotation of the polarization axis is achieved using multi-axis optical fiber squeezing that produces linear birefringence in the fiber, altering the polarization state of the optical signal passing through it. Given the time-dependent polarization state of the input photonic signal, the adjuster must continually adjust the degree of rotation in the polarization state to attain a stable, maximized output at the PBS.

The adjuster accomplishes this task via an internal PID algorithm. The firmware is able to take operational parameters that affect the PID function. The purpose of the two single photon detectors in the experimental design is primarily to perform BSM projections. The single photon detectors accomplish the BSM by performing bipartite detection of qubits from Alice and Bob (e.g., signals detected at both detectors). Single photon detector technology makes use of a superconducting circuit to detect the absorption of a photon by registering a temporary nonequilibrium increase in the circuit's temperature and subsequent electrical resistance. The single photon detector is sensitive to visible and infrared wavelengths and has certain advantages relative to other single-photon detectors, including increased timing resolution and recovery rate.

Single photon detector technology utilizes a superconducting circuit that detects photon absorption by registering a temporary increase in the circuit's temperature and subsequent electrical resistance. These detectors are sensitive to both visible and infrared wavelengths and offer advantages over other types of single-photon detectors, including enhanced timing resolution and recovery rates. Projection into a Bell state can be performed by the single photon detectors regardless of the time-bin states that Alice and Bob (101a, b) prepare.

The described functionality primarily necessitates three specifications for the single photon detectors: high detection efficiency, sufficiently short dead time to register each qubit arrival, and excellent timing resolution (timing jitter) to distinguish between |e [symbol] and |l [symbol] states with a high signal-to-noise ratio (SNR). A detection efficiency ideally close to 1 is preferred, though 0.9 is sufficient, especially considering the current state-of-the-art is approximately 0.95.

Considering a qubit preparation rate of 200 MHz, a reasonable assumption is that the dead time of single photon detectors should be less than 5 ns to ensure detection of all arriving qubits. This requirement can be slightly relaxed when only |ψ− [symbol] projections are used for establishing the cryptographic key, as only 25% of Bell state measurements (BSMs) project onto the |ψ− [symbol] state. Therefore, the average time between |ψ− [symbol] projections is expected to be around 20 ns, not accounting for other factors. In practical terms, the system parameters include qubit preparation at 200 MHz, a mean photon number per laser pulse of approximately 0.3 (including vacuum, decoy, and signal states), channel loss of 0.2 dB/km, insertion loss at Charlie (131) around 5 dB, and detector efficiency of about 90%. Consequently, a single photon detector dead time of approximately 600 ns may be sufficient to register, on average, all |ψ− [symbol] projections.

The BSM component of the BSM board 135 converts electrical signals from single photon detectors, corresponding to detection patterns projecting onto the |ψ− [symbol] Bell state, into a Boolean electrical output. Other Bell states are not utilized in this embodiment due to the experimental setup's use of linear optics (a beam splitter), absence of heralding or auxiliary photons, and non-photon-number-resolving single photon detectors with a dead time. For a given qubit preparation event, when an |e [symbol] qubit is detected in one single photon detector and an |l [symbol] is detected in the other, the BSM board outputs an electrical signal of “True” to the central FPGA at Charlie, indicating a successful |ψ− [symbol] measurement is recorded.

Due to the use of linear optics without auxiliary photons in this embodiment, it is not feasible to unambiguously project onto the |Φ+ [symbol] and |Φ− [symbol] states based on detection patterns. Therefore, the projection onto a single Bell state can only occur 50% of the time. If the detector's dead time were less than the separation between early and late time bins, it would also be possible to detect |ψ+ [symbol] Bell states. These could potentially replace or supplement the |ψ− [symbol] measurements.

Photons are detected randomly on separate detectors or the same detector. Consequently, the rate of coincidence counts using photons at the same time-bin decreases when photons are indistinguishable. This information can provide feedback to any system component capable of modifying distinguishability in a photonic degree of freedom. Therefore, HOM interference is utilized to ensure time-dependent matching of laser wavelengths.

The receiver communicates with the transmitters in this embodiment via fiber optic cables 151a, b. To send a signal to the transmitter, the receiver comprises dense wavelength-division multiplexing (DWDM) small form-factor pluggable (SFP) transceivers. Each transceiver takes several electrical input signals and converts them to optical signals before multiplexing the various generated wavelengths corresponding to the electrical inputs. It then sends the multiplexed optical signal as output.

In the present embodiment, the enhancement of the polarized optical signal directed to the interference device or PMBS, as previously disclosed, is achieved through the utilization of an adaptive optimization algorithm, such as PID.

Photonic signals from Alice and Bob enter polarization adjuster 140a and 140b, respectively. Each polarization axis is rotated, and the respective signal enters its corresponding PBS where only the portion of the optical polarization axis that is parallel with one of the two orthogonal polarization axes of the PBS is sent to the PMBS. The output port used in each PBS should have polarization axes that are parallel with each other. Here the photonic signals from Alice and Bob interfere and are output to the two single photon detectors. The single photon detectors produce the electrical signal for each photon detection event. The pulses are sent to the micro-controller where they are sampled and counted. The micro-controller then sends a signal relating to the number of counts recorded from the single photon detectors back to one of the polarization adjusters as a polarization feedback signal. The micro-controller may send the feedback signal to one polarization adjuster at a time, and in this case alternating between them while maintaining the feedback voltage sent to the inactive polarization adjuster. The objective of this system is to maximize the number of photons that are directed to the parallel output ports of each PBS, relayed to the PMBS, and correspond to detection events.

The adjusters are capable of rotating the polarization state of the incoming photonic signal anywhere on the Poincaré sphere to maximize the feedback signal. Consequently, they rotate the polarization axis of their respective linearly polarized signals to maximize the portion of the signal that is output at the PBS output port that is connected to the PMBS. Using this method, the gain of the signals from Alice and Bob are maximized, and therefore the secure-key rate and secure distance are also maximized.

The polarization drift of the incoming signals in the quantum channels is a relatively slow effect, it is not necessary for the adjusters to respond quickly to perturbations, but they must be capable of stable operation in maximizing the photonic signals at the single photon detectors. The critical performance metrics here are the sampling rate of the processing unit and the frequency of the feedback output signal sent from the processing unit to the polarization adjusters. To sample the pulses from the single photon detectors with high fidelity, the processing unit should be capable of sampling at the Nyquist rate, a rate of at least twice the frequency of the sampled signal. In this embodiment, a sampling rate of at least 50 MHz (or at least 100 MHz) may be used to allow sufficient feedback to be provided.

In another embodiment, a first micro-controller with a clock rate of around 80-90 MHz was used to for sampling the fast signals from the single photon detectors. In a second embodiment, an FPGA with dual-core 667 MHz processors was used. Perturbation recovery using FPGA control was found to be superior to that of the first micro-controller. This may be because the FPGA is capable of sampling at well over the 100 MHz Nyquist limit. Consequently, count rates with the FPGA when sampling pulses from the single photon detector were found to be more accurate.

Further, the step size of each correction increment can be adjusted and used in the maximization algorithm. Moreover, the adjuster can rotate the polarization state anywhere on the Poincaré sphere to find the optimal position that maximizes the provided feedback signal.

Larger step size allows the adjusters to find the point of maximization more quickly, but the response of the adjuster is relatively coarse which leads to noisier operation in the steady state. With small step sizes, the response of the adjuster is slower but the resolution on the Poincaré sphere is greater, leading to less noise in steady-state operation.

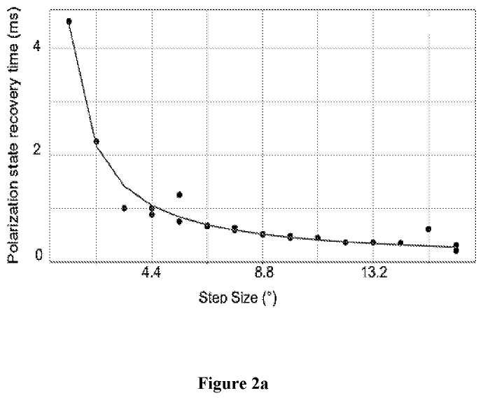

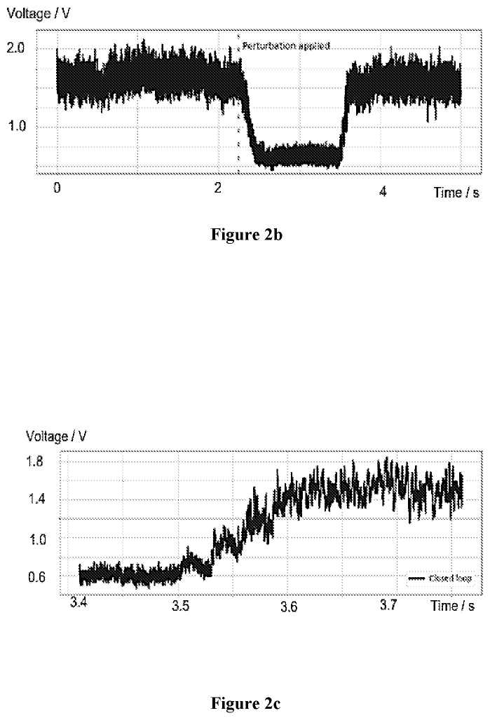

The step size parameter is found to make a significant impact on feedback signal stability and response time to polarization perturbations. As shown in FIG. 2a, the dependence of the adjuster's recovery time on step size is characterized, which shows the polarization adjuster characterization of response time to perturbations in the polarization state as a function of step size. Here, the adjuster is operated in closed-loop mode using optical signal with classical intensity at 1550 nm, a PBS to isolate the polarization component. An analog voltage feedback signal is provided to the adjuster from the PD. Perturbations are induced by minimizing the light output of the PBS with the adjuster disabled, and then enabling the adjuster and observing the feedback signal maximization response.

An empirical power-law relationship is identified, demonstrating that larger step sizes substantially reduce recovery time from perturbations while concurrently introducing a more pronounced steady-state feedback signal noise. Given the anticipated slow timescale of polarization drift, spanning seconds to minutes, emphasis is placed on achieving maximum resolution and stable operation, thereby prioritizing these factors over rapid response time.

Another factor in the performance of above-described feedback-based polarization control system relates to the rate of feedback. Given that the incoming signals from the single photon detector have a rate of hundreds of kHz, assuming an integration period of τs=1 ms yields hundreds of counts per integration cycle; a quantity yielding a minimally adequate SNR of the feedback signal. This corresponds to a maximum update rate of the feedback signal of 1 kHz. The polarization adjuster should be able to receive feedback at a rate of 1 kHz or less.

FIGS. 2b and 2c illustrate the response of a polarization adjuster to a perturbation induced by a manual polarization controller, resulting in a noticeable dip in voltage, altering the polarization of a photonic signal at 1550 nm under FPGA control.

FIG. 2b corresponds to a perturbation in the polarization state being applied with the adjuster in closed-loop mode, where the recovery is evident.

FIG. 2c corresponds to a subset of the closed-loop data showing the recovery over a short timescale.

In the described embodiment, the alignment of polarization for each input signal is optimized to maximize the total count detected by the detectors. This design enables the use of the same detectors for both key distribution and polarization feedback, thereby reducing the overall number of detectors required. Alternatively, in other embodiments, separate detectors may be positioned at the unused output ports of the PBSs (those not directed towards the PMBS), and the feedback mechanism may focus on minimizing photon detections at these unused outputs. This configuration has the advantage that each non-used output will only receive photons from one of the transmitters, thereby allowing the polarization adjuster to be adjusted based on just photons which have passed through that polarization adjuster.

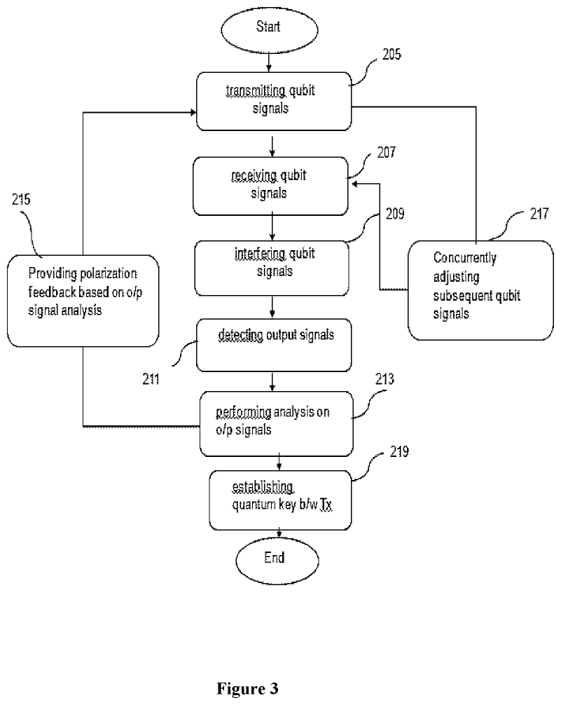

Referring to FIG. 3, FIG. 3 illustrates the method of Establishing a Cryptographic key.

FIG. 3 represents a method of establishing at least a portion of a cryptographic key. In the first step, each transmitter transmits qubit signals (205) within specific time windows, characterized by bases and modes. Signals are temporally spaced and correspond to a basis and mode. After then, the receiver gathers (207) qubit signals from all transmitters. Qubit signals from multiple transmitters are interfered (209) to create an output signal. After, multiple received qubit signals are interfered to produce an output signal, detectors detect the resulting output signal (211) from interference. Further, the output signals are analyzed for polarization information on detected output signals (213), and automatically provide feedback (215) to transmitters based on qubit polarization information. Transmitters which transmit the qubit signal (205) receive feedback from the receiver based on polarization information (213) and transmitting qubit signals (205) are concurrently adjusted in receiver (217) and receiver receives concurrently adjusted qubit signals (207). Transmitters transmitting qubit signals (205) concurrently adjust subsequent qubit signals based on received feedback (217). The qubit signals are adjusted based on received feedback (217), the part of cryptographic key or cryptographic key is established (219) by using transmitted information about detected output signals.

Although the present invention has been described and illustrated with respect to preferred embodiments and preferred uses thereof, it is not to be so limited since modifications and changes can be made therein which are within the full, intended scope of the invention as understood by those skilled in the art.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within scope of the appended claims.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between. The scope of the embodiments of the present invention is ascertained by the claims to be submitted at the time of filing the complete specification.

1. A quantum communication system comprising:
at least two transmitters; and
a receiver;
wherein each of the transmitters comprises:
a light source configured to transmit a series of temporally spaced apart qubit signals, each qubit signal being within a respective time window, and corresponding to a basis within a plurality of bases, and a mode within a plurality of modes of the basis; and
a transmitter controller configured to control the series of qubit signals emitted by the light source; and
the receiver comprising:
an interference device having multiple inputs configured to receive the series of qubit signals from each of the transmitters, and multiple outputs configured to output an output signal based on an interference of the received qubit signals at the interference device; and
a plurality of detectors configured to detect the output signal at the multiple outputs of the interference device; and
a receiver controller configured to:
transmit information concerning the detected output signals to the transmitters; and
provide polarization feedback including information pertaining to a plurality of the detected output signals;
wherein the quantum communication system is configured concurrently to:
adjust one or more characteristics of subsequently transmitted qubit signals based on the provided feedback, wherein the characteristics based on polarization similarity of the qubit signals; and
facilitate establishment of at least part of a cryptographic key between the transmitters based on the transmitted information concerning the detected output signals.

2. The quantum communication system according to claim 1, wherein the system is configured to make subsequent adjustments to the transmitted qubit signals based on the most recently received feedback, and further based on previous adjustments and associated feedback.

3. The quantum communication system according to claim 1, wherein the receiver controller is configured to monitor a coincidence rate of simultaneously arriving signals at multiple different detectors, and to provide polarization feedback based on the determined coincidence rate.

4. The quantum communication system according to claim 3, wherein each polarization adjuster is configured to adjust the polarization of the incoming qubit signals from one of the transmitters based on the polarization feedback by an amount, wherein the amount is determined based on a rate of detected signals at the detectors.

5. The quantum communication system according to claim 1, wherein each polarization adjuster adjusts the polarization of the qubit signals by applying a strain to a fiber optic cable carrying the qubit signals.

6. The quantum communication system according to claim 1, wherein each light source comprises a laser, and each receiver comprises a polarization adjuster configured to adjust the polarization of the incoming qubit signals.

7. The quantum communication system according to claim 1, wherein the qubit signal exhibits a full-width half maximum of less than 500 ps.

8. The quantum communication system according to claim 1, wherein the qubit signals are conveyed from the transmitter to the receiver through a fiber optic cable.

9. The quantum communication system of claim 1, wherein at least one of the transmitter and receiver controllers incorporates a Field-Programmable Gate Array (FPGA).

10. The quantum communication system of claim 1, wherein polarization feedback is provided on characteristics of the qubit signals and an analysis of the output signals conducted over distinct respective time periods.

11. The quantum communication system of claim 1, wherein the establishment of the cryptographic key is based on information derived from detected output signals corresponding to Bell states or GHZ states.

12. The quantum communication system of claim 1, wherein the establishment of the cryptographic key is based on information derived from detected output signals corresponding to a photon detected in an early bin at a first detector and a photon detected in a late bin at a second detector.

13. The quantum communication system of claim 1, wherein each qubit signal among the transmitted qubit signals is encoded utilizing early and late time bins within the respective time window.

14. A quantum communication system receiver comprising:
an interference device with multiple inputs configured to receive multiple series of temporally spaced apart qubit signals from multiple transmitters, and multiple outputs configured to output an output signal based on the interference of the received qubit signals at the interference device;
multiple detectors configured to detect the output signal at multiple outputs of the interference device; and
a receiver controller configured to:
transmit information concerning the detected output signals to the transmitters; and
provide polarization feedback based on the outputs, wherein the feedback is derived from information determined through analysis of a plurality of the detected output signals and pertains to polarization similarity of the qubit signals.

15. A method of establishing at least a portion of a cryptographic key, the method comprising:
transmitting a controlled series of temporally spaced apart qubit signals from each of a plurality of transmitters, each qubit signal being within a respective time window, and corresponding to a basis within a plurality of bases, and a mode within a plurality of modes of the basis;
receiving the qubit signals at a receiver;
interfering multiple received qubit signals from the multiple transmitters to produce an output signal based on an interference of the received qubit signals at the interference device;
detecting the output signals; and
transmitting information relating to the detected output signals to the transmitters, automatically providing polarization feedback based on information determined from an analysis of a plurality of the detected output signals, wherein the polarization feedback corresponds to characteristics of the qubit signals, the characteristics comprising: polarization similarity of the qubit signals;
concurrently adjusting subsequently transmitted qubit signals based on the received feedback; and
establishing at least part of a cryptographic key between the transmitters based on the transmitted information relating to the detected output signals.

16. A method as claimed in claim 15, wherein the interference device comprises a beam splitter or a Mach-Zehnder interferometer.

17. A method as claimed in claim 15, wherein the analysis of the detected output signals includes determining the degree of entanglement between qubit pairs.
